(19) United States
(12) Patent Application Publication
(10) Pub. No.: US 2004/0227965 A1
(43) Pub. Date: Nov. 18, 2004

(54) Dot data creation process with saved memory capacity

(75) Inventor: Hisanori Nakajima, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/785,481

(22) Filed: Feb. 25, 2004

(30) Foreign Application Priority Data
Feb. 26, 2003 (JP) 2003-48823(P)

(51) Int. Cl. H04N 1/52; H04N 1/60; G06K 15/10

(52) U.S. Cl. 358/1.9; 358/502; 358/1.2; 358/518; 358/534; 358/1.16; 358/524

(57) ABSTRACT

A method of the present invention first stores color image data for an area corresponding to a height of entire nozzles in the sub scanning direction that are used during color printing into a line selection process buffer BF12. Then, the method selects color image data for printing-subject lines subject to recording of ink dots during a single main scan from the buffer BF12. In addition, the method performs on the color image data the color conversion process and the dither process in the printing resolution to create dot data representing recording states of ink dots in print pixels on the printing-subject lines, and then stores the dot data into a buffer BF14.

### BACKGROUND OF THE INVENTION

1. Field of the Invention

The present invention relates to a technique for ejecting ink from nozzles of a print head during main scanning to perform color printing.

2. Description of the Related Art

Ink jet printers are widely used as output devices of computers. Recently, the printing resolution of ink jet printers tends to increase in order to attain higher picture quality, and the number of nozzles per each color tends to increase in order to attain higher speed.

In order to print by means of the ink jet printer, a process is performed that creates dot data representing recording states of ink dots of each ink from color image data such as RGB data. In this process, a large amount of buffer memory is used, and the increased printing resolution and/or the increased number of nozzles cause the required capacity of the buffer memory to be significantly increased. For example, if the printing resolution is doubled both in the main scanning direction and in the sub scanning direction, then the number of pixels within the printed area quadruples. In this case, the capacity of the buffer memory also quadruples by simple arithmetic. Alternatively, the capacity of the buffer memory increases by 16-fold if the printing resolution quadruples.

However, the memory resource available as the buffer memory is limited. Consequently, there has been a desire for reducing the capacity of the buffer memory that is required during the dot data creation process.

An object of the present invention is to provide a technique for reducing the capacity of the buffer memory that is required during the dot data creation process.

### SUMMARY OF THE INVENTION

According to an aspect of the present invention, there is provided a method of creating dot data representing recording states of ink dots in order to perform color printing by ejecting ink from nozzles of a print head during main scanning to thereby record ink dots on a printing medium. The method comprises the steps of: (a) providing a print head that includes a plurality of nozzle groups for ejecting plural types of inks, respectively, wherein each of the plurality of nozzle groups includes a plurality of nozzles whose nozzle pitch in a sub scanning direction is larger than a pitch of print pixels; (b) storing color image data for an area corresponding to a height of entire nozzles in the sub scanning direction that are used during color printing into a first buffer; (c) selecting color image data that represent a color image part on a plurality of printing-subject lines subject to recording of ink dots performed by the plurality of nozzle groups during a single main scan from the first buffer; (d) performing at least a halftone process that uses a threshold pattern having the printing resolution on the selected color image data on the plurality of printing-subject lines to create dot data representing recording states of ink dots in print pixels on the selected printing-subject lines, and storing the dot data into a second buffer; and (e) outputting the dot data from the second buffer.

The present invention may take a variety of forms other than the above-mentioned dot data creation method, for example, a printing method and printer; a print control method and print controller; a printing system including a printer and computer; a computer program for realizing the functions of these methods and devices; a storage medium storing the program; and so on.

### BRIEF DESCRIPTION OF THE DRAWINGS

FIG. 1 is a block diagram that shows a structure of a printing system as one embodiment of the present invention.

FIGS. 2(A) and 2(B) schematically illustrate the relationship between an image data resolution Rdata and a printing resolution Rprint.

FIG. 3 is a schematic diagram that shows an arrangement of nozzles on a bottom surface of a print head 210.

FIG. 4 is a schematic diagram that shows an exemplary dot recording method performed by a printer 200.

FIG. 5 is a schematic diagram that shows a procedure of a print data generation process according to a comparative example.

FIG. 6 is a schematic diagram that shows details of a data rearrangement process according to the comparative example.

FIG. 7 is a schematic diagram that shows a procedure of a print data generation process according to the embodiment.

FIGS. 8(A) through 8(C) are schematic diagrams that show three types of buffers BF12 through BF14 used in the embodiment.

FIG. 9 is a schematic diagram that shows details of the color conversion process and the dither process according to the embodiment.

FIGS. 10(A) and 10(B) show comparison of the buffer memory capacities according to the comparative example and the embodiment.

### DESCRIPTION OF THE PREFERRED EMBODIMENTS

Modes of the present invention are described through embodiments in the following sequence.

A. General Configuration of Printing System

B. Process According to Comparative Example

C. Process According to Embodiment

D. Modifications

A. General Configuration of Print System:

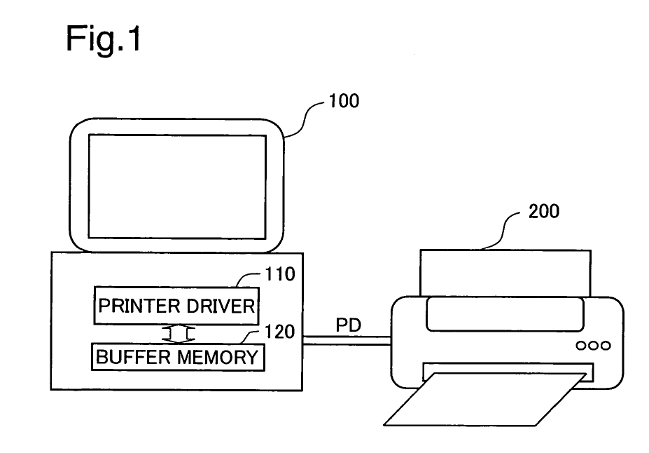

FIG. 1 is a block diagram that shows a structure of a printing system as one embodiment of the present invention. This printing system includes a computer 100 and a printer 200, which are connected with each other. A printer driver 110 is installed on the computer 100. The printer driver 110 receives image data from an application program (not shown), performs a color conversion process and a halftone process with the aid of a buffer memory 120 to generate print data PD, and then supplies the print data PD to the printer 200. The print data PD includes dot data that specify recording states of ink dots for each pixel on main scanning lines having a printing resolution, and sub scanning feed amount data that specify sub scanning feed amounts. The printer driver 110 corresponds to a computer program for realizing a function of generating dot data for printing.

The program for realizing the function of the printer driver 110 may be stored in a computer readable recording medium. Such recording medium may include a variety of computer readable media such as flexible disk, CD-ROM, magneto-optics disc, IC card, ROM cartridge, punched card, and a print with barcodes or other codes printed thereon.

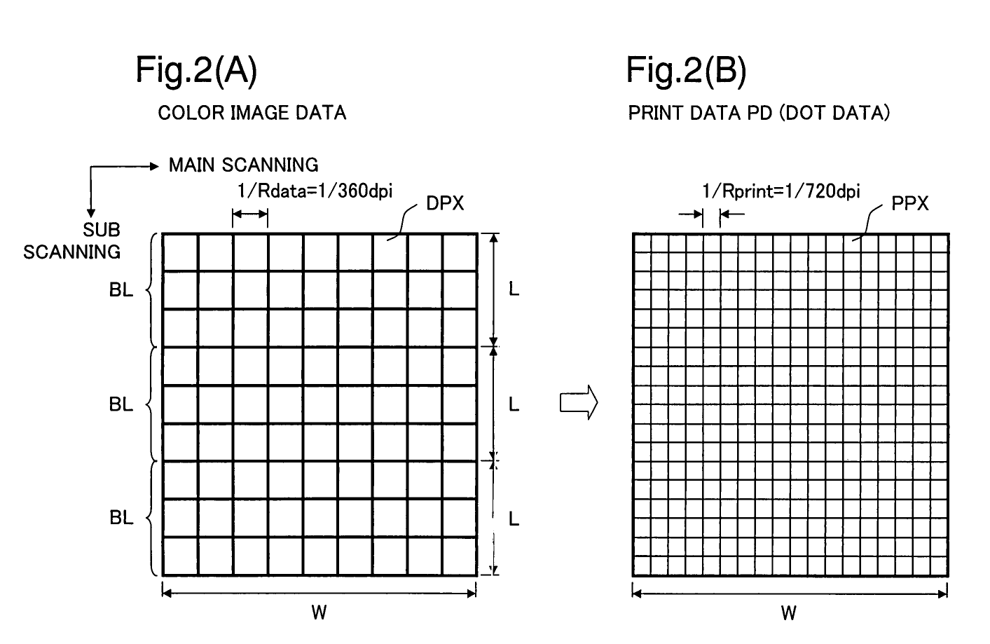

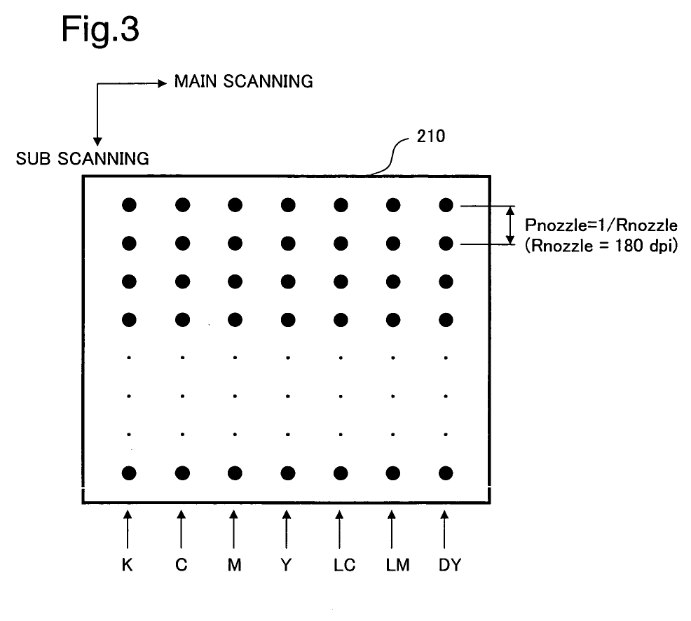

FIGS. 2(A) and 2(B) are schematic diagrams that show the relationship between a resolution Rdata of color image data received by the printer driver 110 and a resolution Rprint of the print data (or dot data). In this embodiment, the resolution Rdata of color image data (referred to as “image data resolution”) is equal to 360 dpi, and the resolution Rprint of print data PD (referred to as “printing resolution”) is equal to 720 dpi. In other words, a single pixel DPX of color image data has a pitch of 1/360 inch and a print pixel PPX has a pitch of 1/720 inch. The printing resolution Rprint is often set to a value higher than the image data resolution Rdata. Although the printing resolution in the main scanning direction is equal to that in the sub scanning direction in the example of FIG. 3, the former may be different from the latter.

In the dot data creation process performed by the printer driver 110, the color image data are processed in units of bands BL of a predetermined size. The bands BL have a width W in the main scanning direction, which is equal to that of a printed area, and a height L (a number of lines) in the sub scanning direction, which has been set in advance. In the following description, it is assumed that the bands BL have the width W of 8 inches in the main scanning direction and the height L corresponding to 100 lines in the sub scanning direction.

FIG. 3 is a schematic diagram that shows an arrangement of nozzles on a bottom surface of a print head 210 of the printer 200. The print head 210 is provided with seven nozzle groups. The seven nozzle groups are used to eject seven types of inks that include black ink K, cyan ink C, magenta ink M, yellow ink Y, light cyan ink LC, light magenta ink LM, and dark yellow ink DY. The light cyan ink LC has same hue as the cyan ink C and lower density. This is also true for the light magenta ink LM. The dark yellow ink DY has some gray component added to the yellow ink Y. Each of the nozzle groups has a same number of nozzles, which are arranged at regular nozzle pitches Pnozzle along the sub scanning direction. In this specification, an inverse number Rnozzle of the nozzle pitch Pnozzle is referred to as “nozzle resolution.” In the example of FIG. 3, the nozzle resolution Rnozzle is equal to 180 dpi. The nozzle resolution Rnozzle is often set to a value lower than the printing resolution Rprint.

Some of the nozzle groups (e.g. black nozzle group) may have more nozzles than the other nozzle groups and/or may have a smaller nozzle pitch that is equal to an integral division of the nozzle pitch of the other nozzle groups. Even in such cases, usually the same number of nozzles included in each of the nozzle groups are selectively used to print color images. In general, the print head 210 may include any print heads that have a plurality of nozzle groups for ejecting plural types of inks.

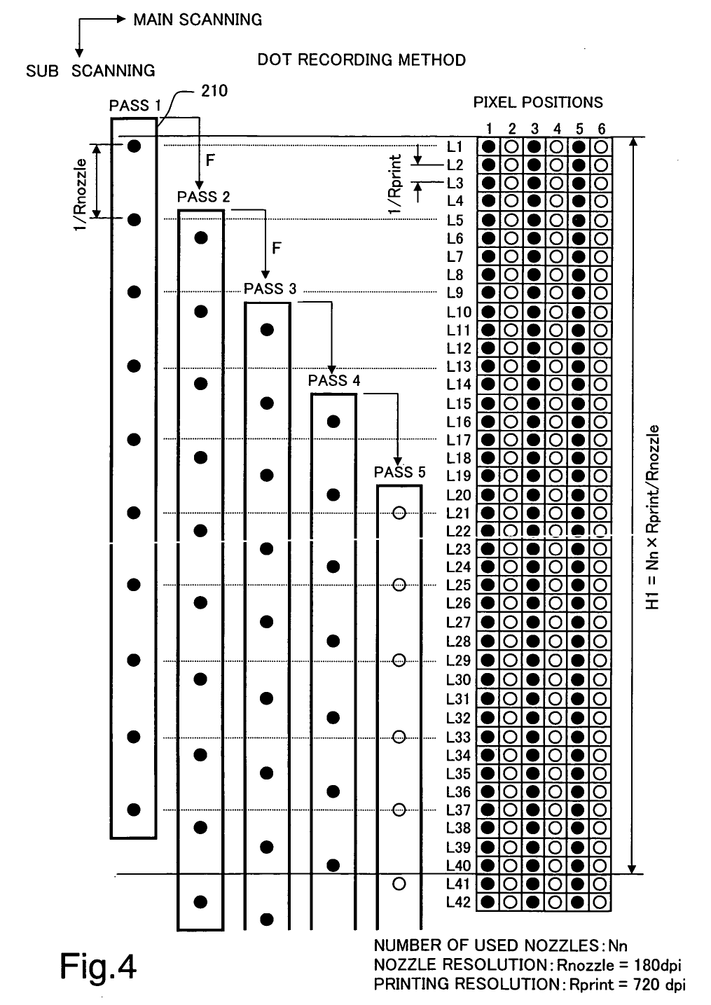

FIG. 4 is a schematic diagram that shows an exemplary recording method (i.e. printing method) performed by means of the print head 210. On the left hand of FIG. 4, there are shown positions of the print head 210 during five main scan passes. For convenience of illustration, FIG. 4 is simplified so that a single nozzle group for a single type of ink represents the print head 210 and the number Nn of used nozzles in the nozzle group is equal to 10. On the right hand of FIG. 4, there are shown positions of print pixels subject to recording on a printing medium. Each of small square frames represents a print pixel. The pixel positions with solid circles (odd-numbered pixel positions) and the pixel positions with open circles (even-numbered pixel positions) are subject to recording of dots on mutually different passes. This will be described later.

In this example, a sub scan is performed with a regular feed amount F of 5 dots whenever each main scan pass is completed. Although the printing medium is typically moved during the sub scanning, FIG. 4 is drawn for convenience of illustration as if the print head 210 were moved. The sub scanning causes the positions of nozzles to be sequentially shifted in the sub scanning direction. The feed amount F may differ among sub scans in some recording methods.

On the pass 1, ten main scanning lines L1, L5, L9 . . . L37 are scanned by the ten nozzles of the print head 210. Therefore, these ten main scanning lines L1, L5, L9 . . . L37 are subject to recording of ink dots. In addition, among pixels on these main scanning lines L1, L5, L9 . . . L37, pixel positions with a solid circle are subject to recording of ink dots, that is, recording-subject pixel positions. On the other hand, among pixels on the same scanning lines L1, L5, L9 . . . L37, pixel positions with an open circle are not subject to recording of ink dots on the pass 1, that is, non recording-subject pixel positions. For example, on the line L21, the pixel positions with the solid circle are subject to recoding of ink dots on the pass 1, and the pixel positions with the open circle are subject to recording of ink dot on the pass 5. Pixel positions with the open circle on the main scanning lines L1 through L20 are subject to recording of ink dots on the passes preceding the pass 1 of FIG. 4.

In this specification, the dot recording method as shown in FIG. 4 is referred to as “overlap recording method.” The “overlap recording method” causes pixel positions on the main scanning line to be intermittently and periodically subject to recording of ink dots on a single main scan pass. Therefore, in the overlap recoding method, the total number of main scans performed on each main scanning line is equal to or more than 2, and dots on each main scanning line are recorded by two or more different nozzles. Although in the example of FIG. 4 the total number of main scans performed on each main scanning line is equal to 2, the total number may be set to three or more. Such overlap recording method enables positional misalignment of dots due to the manufacturing error of nozzles to be reduced, thereby providing the advantage of improved picture quality. However, the recording method of FIG. 4 is merely exemplified, and another recording method may be applied instead of the overlap recording method.

In the comparative example and embodiment described below, the following parameters are used to describe generation processes of print data.

Width W of the band BL (FIG. 2(A)): the width of the band BL in the main scanning direction, which is a unit for processing the image data.

Height L of the band BL (FIG. 2(A)): the number of lines in the sub scanning direction included in the band BL.

Image data resolution Rdata (FIG. 2(A)): the resolution of the original color image data (RGB data).

Printing resolution Rprint (FIG. 2(B)): the resolution during the printing. In the following description, it is assumed that the printing resolution in the main scanning direction is equal to that in the sub scanning direction.

Nozzle resolution Rnozzle (FIG. 3): the resolution that defines the pitch of nozzles in the sub scanning direction.

Number Nn of used nozzles (FIG. 4): the number of nozzles used for each ink color during color printing.

Number Nc of ink colors (FIG. 3): the number of ink colors used during color printing.

B. Process According to Comparative Example:

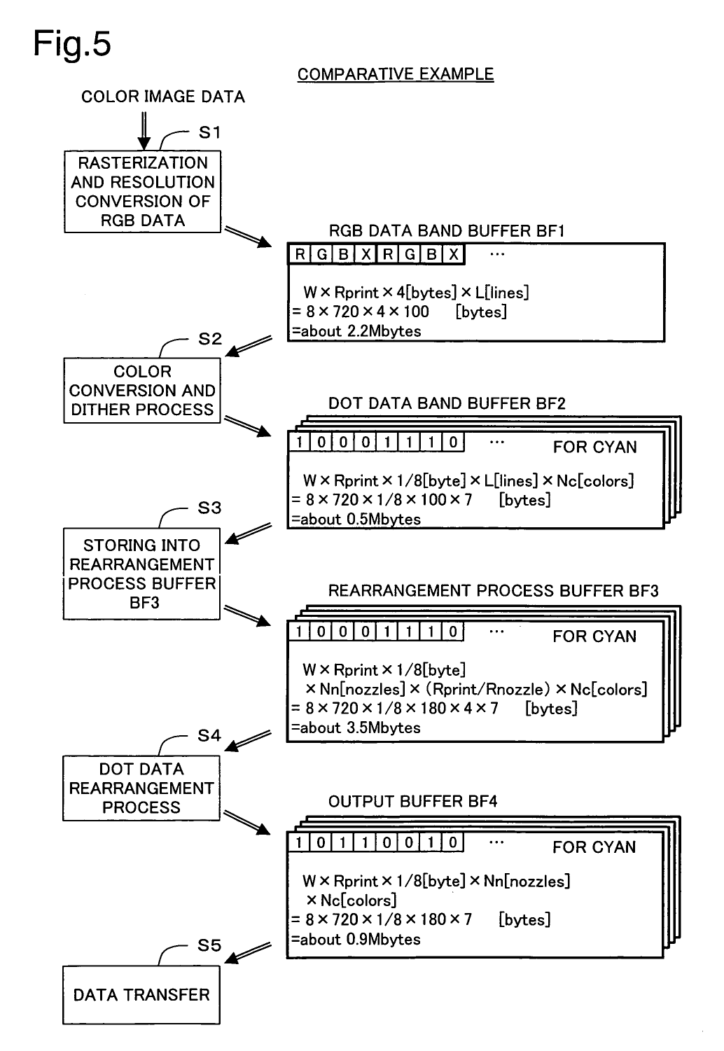

A comparative example of the generation process of print data in is described as prior to the description of the process according to one embodiment. FIG. 5 is a schematic diagram that shows a procedure of the print data generation process according to the comparative example, and a buffer memory used for the process. Steps S1 through S5 shown in FIG. 5 are performed by the modules included in the printer driver 110. Each module included in the printer driver 110 is also referred to as a “processor.”

When the printer driver 110 receives the color image data from the application program, it performs rasterization and resolution conversion on the RGB data at step S1 to generate RGB data that have the printing resolution Rprint (FIG. 2). Then, the printer driver 110 stores the RGB data into a RGB data band buffer BF1. Where the “rasterization” denotes a process that arranges the color image data for each main scanning line. The rasterization does not be required when the original color image data are bitmap data while the rasterization may be required when the original data are draw data or compressed data.

The color image data received by the printer driver 110 from the application program may have a variety of data structures, such as RGB data and JPEG data. The typical color image data use three color components to express any colors.

The printer driver 110 receives the RGB data from the application program, simply increase its resolution to the printing resolution Rprint, and then stores the resulting data into the band buffer BF1. For example, when the resolution Rdata of the original RGB data is equal to 360 dpi and the printing resolution Rprint is equal to 720 dpi as shown in the example of FIG. 2, the resolution conversion causes a pixel value of an original single pixel DPX to be assigned to 2×2 print pixels PPX.

The band buffer BF1 shown in FIG. 5 has the capacity for storing RGB data for the single band BL (FIG. 2(A)). As described above, the band BL is a unit for processing the image data during the creation of dot data. The capacity CP[BF1] of the band buffer BF1 is given by the following equation (1):

CP[BF1]=W×Rprint×4×L (1)

Where the value “4” represents the number of bytes of RGB data for each single pixel. As shown in FIG. 5, the RGB data for each single pixel stored in the band buffer BF1 have the 4-byte data structure that consists of R, G, and B components of 8 bits, and stuff bits X of 8 bits. Assuming that W=8 inches, Rprint=720 dpi, and L=100 lines, the capacity CP[BF1] of the band buffer BF1 is approximately 2.2 Mbytes.

At step S2, the printer driver 110 sequentially reads out the RGB data from the band buffer BF1, performs the color conversion process and the dither process on the data, and then stores the resulting dot data into a dot data band buffer BF2. The color conversion process uses a color look-up table (not shown) to convert the RGB data into data of plural ink colors (referred to as “ink color data”). The dither process compares a predetermined threshold pattern having the printing resolution with the ink color data to generate the dot data.

The dot data band buffer BF2 has the capacity for storing dot data for the single band BL. The capacity CP[BF2] of the band buffer BF2 is given by the following equation (2):

CP[BF2]=W×Rprint×(1/8)×L×Nc (2)

Where the value “1/8” represents the number of bytes of dot data for each single pixel. That is, it is assumed that the dot data of each single ink color for each single pixel have 1 bit (or 1/8 bytes). In general, if the dot data of each single color for each single pixel have M bits, the capacity CP[BF2] is obtained by multiplying the right hand side of the equation (2) by M. This is also applicable to the other equations described later. Assuming that W=8 inches, Rprint=720 dpi, L=100 (lines), and Nc=7 (ink colors) in the above equation (2), the capacity CP[BF2] of the band buffer BF2 is approximately 0.5 Mbytes.

At step S3, the printer driver 110 reads out the dot data to be used in a dot rearrangement process (step S4) from the band buffer BF2, and then stores the dot data into a rearrangement process buffer BF3. The capacity CP[BF3] of the rearrangement process buffer BF3 is given by the following equation (3):

CP[BF3]=W×Rprint×(1/8)×Nn×(Rprint/Rnozzle)×Nc (3)

As shown in FIG. 4, the term {Nn×(Rprint/Rnozzle)} represents the number of main scanning lines included within the height H1 of the print head 210 in the sub scanning direction. In other words, the height H1 corresponds to the height of entire nozzles in the sub scanning direction that are used during color printing. As can be seen from this, the rearrangement process buffer BF3 stores the dot data over a range in the sub scanning direction of an area that is scanned on the single pass. In this manner, the minimum data to be stored into the buffer BF3 include data within an area defined by the nozzle positions at the both ends of the print head 210, and the height of the area in the sub scanning direction is given by {(Nn−1)×(Rprint/Rnozzle)+1}. However, there is only the insignificant difference between this value and the above-mentioned height H1, and therefore the former value is substantially equal to the latter value. Assuming that W=8 inches, Rprint=720 dpi, Nn=180 (nozzles), Rnozzle=180 dpi, and Nc=7 (ink colors), the capacity CP[BF3] of the band buffer BF3 is approximately 3.5 Mbytes according to the equation (3).

At step S4, the printer driver 110 performs the rearrangement process on the dot data, and then stores the dot data used on the single pass into an output buffer BF4. The rearrangement process extracts and rearranges only the dot data used on a single main scan pass. For example, on the pass 1 shown in FIG. 4, only the odd-numbered pixel positions on the main scanning lines L1, L5, L9 . . . L37 scanned by the nozzles of the print head 210 are subject to recording of dots. Therefore, when the pass 1 is performed, it is required only to extract only the dot data of the recording-subject pixel positions and then supply the dot data from the printer driver 110 to the printer 200.

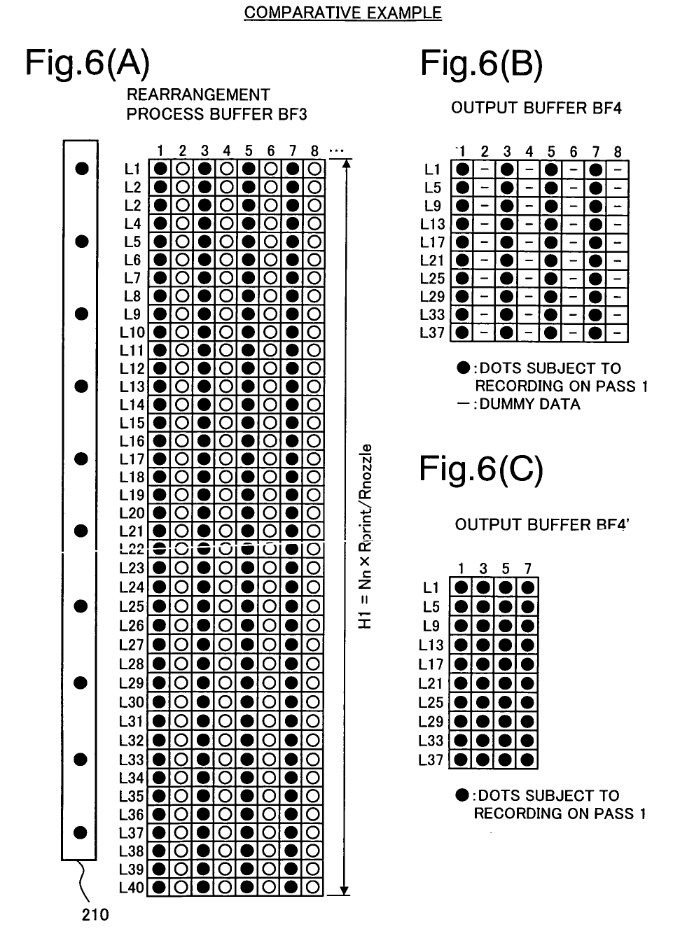

FIGS. 6(A) through 6(C) are schematic diagrams that show details of the data rearrangement process. FIG. 6(A) shows the relationship between the dot data stored in the rearrangement process buffer BF3 and the nozzle positions of the print head 210 in the case of creating the print data for the pass 1 of FIG. 4. The rearrangement process buffer BF3 stores the dot data for all the pixel positions of the forty lines L1 through L40. On the pass 1, only the dot data of the odd-numbered pixel positions on the main scanning lines L1, L5, L9 . . . L37 are used. Therefore, as shown in FIG. 6(B), in the rearrangement process only the dot data of the odd-numbered pixel positions on the main scanning lines L1, L5, L9 . . . L37 are extracted and stored into the output buffer BF4. Furthermore, in the output buffer BF4 the dot data of the even-numbered pixel positions (or non recording-subject pixel positions) on the main scanning lines L1, L5, L9 . . . L37 are replaced with dummy data representing non-formation of dot. Alternatively, the output buffer BF4 may include only the data of the recording-subject pixel positions without the data of non recording-subject pixel positions as shown in FIG. 6(C).

When the output buffer BF4 shown in FIG. 6(B) is used, its capacity CP[BF4] is given by the following equation (4):

CP[BF4]=W×Rprint×(1/8)×Nn×Nc (4)

Assuming that W=8 inches, Rprint=720 dpi, Nn=180 (nozzles), and Nc=7 (ink colors), the capacity CP[BF4] of the output buffer BF4 is approximately 0.9 Mbytes.

At step S5, after the dot data for the single pass have been prepared, the dot data is transferred to the printer 200. In addition, once the dot data for the single pass have been prepared, the oldest dot data for the number of lines corresponding to the sub scanning feed amount F (FIG. 4) among the dot data stored in the rearrangement process buffer BF3 are updated into new dot data. In the example of FIG. 4, the dot data for five lines are updated since the feed amount F corresponds to five lines in the printing resolution.

In the comparative example described above, the total capacity of the buffers BF1 through BF4 is approximately 7.1 Mbytes.

C. Process According to Embodiment:

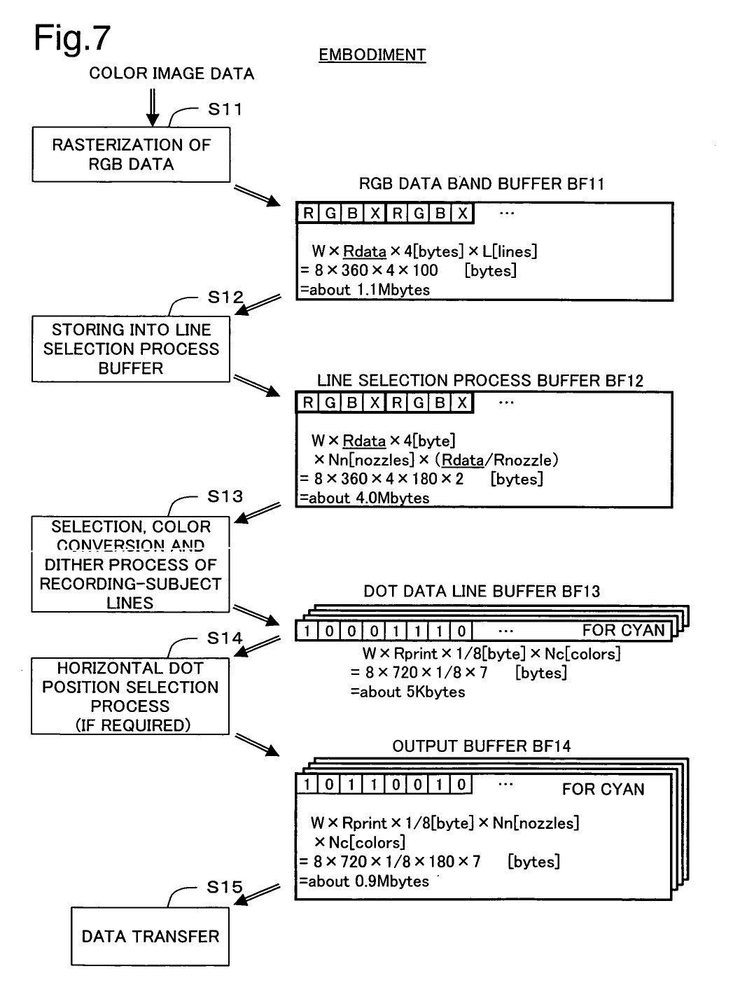

FIG. 7 is a schematic diagram that shows the procedure of the print data generation process according to one embodiment of the present invention, and a buffer memory used for the process. Steps S11 through S15 shown in FIG. 7 are performed by the modules included in the printer driver 110.

At step S11, the printer driver 110 rasterizes the RGB data to generate the RGB data having the image data resolution Rdata (FIG. 2), and then stores the RGB data into the RGB data band buffer BF11. This step differs from step S1 of the comparative example in that the resolution conversion of the RGB data is not performed, and that the RGB data of the image data resolution Rdata is stored in the band buffer BF11. The capacity CP[BF11] of the band buffer BF11 is given by the following equation (5):

CP[BF11]=W×Rdata×4×L (5)

Assuming that W=8 inches, Rdata=360 dpi, and L=100 (lines), the capacity CP[BF11] of the band buffer BF11 is approximately 1.1 Mbytes. The capacity of the band buffer BF11 is equal to a value obtained by multiplying the capacity (approximately 2.2 Mbytes) of the band buffer BF1 according to the comparative example by the ratio (Rdata/Rprint=1/2) of the image data resolution Rdata to the printing resolution Rprint.

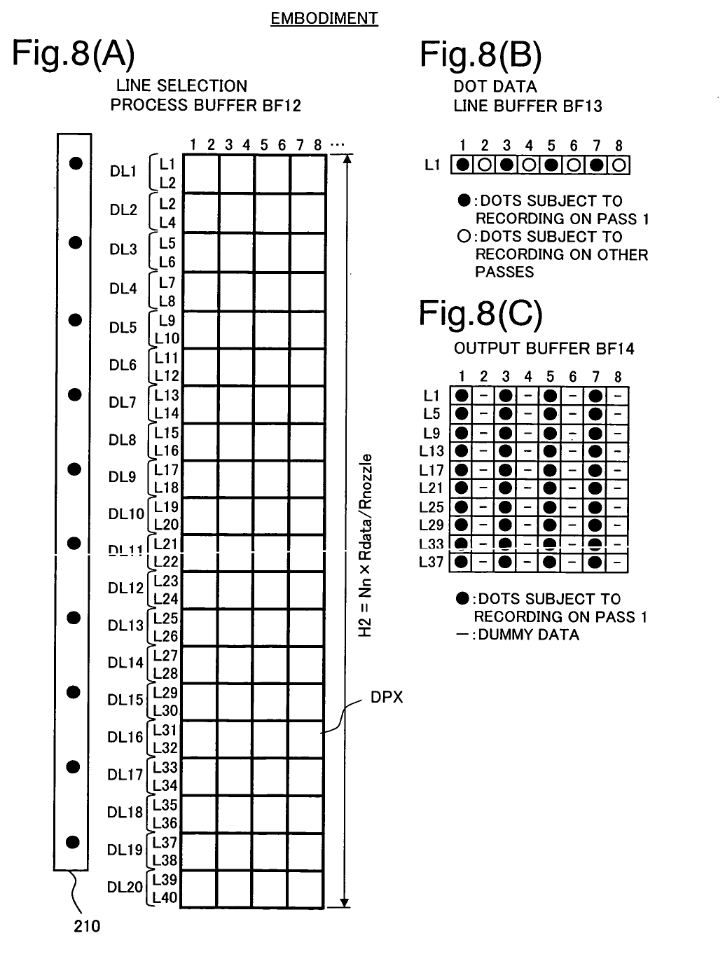

At step S12, the printer driver 110 reads out the RGB data from the band buffer BF11 and then stores the RGB data into a line selection process buffer BF12. The line selection process buffer BF12 is similar to the rearrangement process buffer BF3 of the comparative example, and stores the color image data (or RGB data) within the height H1 (FIG. 4) of the print head 210 in the sub scanning direction. FIG. 8(A) shows the relationship between the image data stored in the line selection process buffer BF12 and the nozzle positions of the print head 210 on the pass 1 shown in FIG. 4. The number of lines DL1 through DL20 of the image data within the height H2 corresponding to the height H1 of FIG. 4 is equal to {Nn×(Rdata/Rnozzle)}. That is, in this embodiment the number of lines {Nn×(Rdata/Rnozzle)} corresponds to the height of entire nozzles in the sub scanning direction that are used during color printing. The minimum data to be stored into the buffer BF12 include data within an area defined by the nozzle positions at the both ends of the print head 210, and the number of lines of the image data corresponding to the height H2 of the area in the sub scanning direction is equal to {(Nn−1)×(Rdata/Rnozzle)+1}. However, there is only the insignificant difference between this value and the above-mentioned value {Nn×(Rdata/Rnozzle)}, and therefore the former value is substantially equal to the latter value.

The capacity CP[BF12] of the line selection process buffer BF12 is given by the following equation (6):

CP[BF12]=W×Rdata×4×Nn×(Rdata/Rnozzle) (6)

Assuming that W=8 inches, Rdata=360 dpi, Nn=180 (nozzles), and Rnozzle=180 dpi, the capacity CP[BF12] of the buffer BF12 is approximately 4.0 Mbytes.

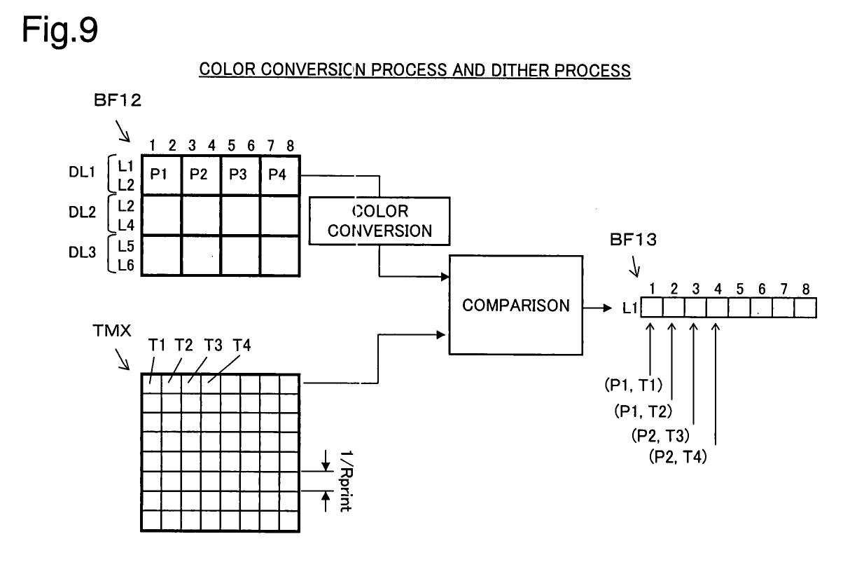

At step S13, the printer driver 110 sequentially selects each line of the image data that is subject to recording on the single pass, and performs the color conversion process and dither process. FIG. 9 schematically illustrates the color conversion process and the dither process according to the embodiment. In FIG. 9, the main scanning line L1 at the top among the main scanning lines having the printing resolution is selected as being subject to recording. In this process, the line DL1 of the image data corresponding to the recording-subject line L1 is first selected and read out from the line selection process buffer BF12. Then, the pixel values on the line DL1 are color-converted into ink color data, and the dither process is performed on the ink color data. The dither process compares the ink color data of pixels P1, P2, P3 . . . on the selected line DL1 with a threshold matrix TMX previously stored in the printer driver 110. Each threshold value of the threshold matrix TMX is assigned to each of pixels T1, T2 . . . having the printing resolution Rprint.

This comparison provides the dot data that represents recording states of dots at the pixel positions on the main scanning line L1 having the printing resolution Rprint. The dot data for each pixel obtained in this manner are sequentially stored into a dot data line buffer BF13. As shown in FIG. 9, the dot data of the first pixel on the main scanning line L1 is obtained by comparing the ink color data of the first pixel P1 on the line DL1 of the image data with the threshold value of the first pixel T1 of the threshold matrix TMX. Furthermore, the dot data of the second pixel are obtained by comparing the ink color data of the first pixel P1 on the line DL1 of the image data with the threshold value of the second pixel T2 of the threshold matrix TMX. As can be seen from this example, in the color conversion and dither process according to this embodiment, an identical pixel value is repeatedly read out (Rprint/Rdata) times from the line selection process buffer BF12. In the same manner, an identical pixel value is also repeatedly read out (Rprint/Rdata) times in the sub scanning direction. The value (Rprint/Rdata) of the number of times is equal to a value of the ratio of the printing resolution Rprint to the image data resolution Rdata. In this manner, according to this embodiment, an identical pixel value of the image data is repeatedly read out (Rprint/Rdata) times to perform the color conversion and dither process, thereby providing the advantage of reducing the amount of the image data stored into the line selection process buffer BF12.

The capacity CP[BF13] of the line buffer BF13 is given by the following equation (7) as shown in FIG. 7:

CP[BF13]=W×Rprint×(1/8)×Nc (7)

Assuming that W=8 inches, Rprint=720 dpi, and Nc=7 (ink colors), the capacity CP[BF13] of the line buffer BF13 is approximately 5 Kbytes (approximately 0.005 Mbytes).

At step S14 of FIG. 7, the printer driver 110 reads out the dot data from the dot data line buffer BF13, performs a horizontal dot position selection process, and then stores the resulting data into an output buffer BF14. The horizontal dot position selection process extracts only dot data used on the single main scan pass among the dot data stored in the line buffer BF13. On the pass 1 of FIG. 4, only the odd-numbered pixel positions on the main scanning line L1 are subject to recording of dots. Therefore, when the pass 1 is performed, the dot data of the recording-subject pixel positions are extracted at step S14. This is also applicable to the other main scanning lines.

FIG. 8(B) shows the dot data of the main scanning line L1 stored in the dot data line buffer BF13 and FIG. 8(C) shows the dot data stored in the output buffer BF14 after the horizontal dot position selection process. The dot data of the even-numbered pixel positions (or non recording-subject pixel positions) on the main scanning line L1 are replaced with dummy data representing non-formation of dot. However, the output buffer BF14 may include only the dot data of the recording-subject pixel positions without the dot data of non recording-subject pixel positions as shown in FIG. 6(C).

The capacity CP[BF14] of the output buffer BF14 is given by the following equation (8) as in the comparative example:

CP[BF14]=W×Rprint×(1/8)×Nn×Nc (8)

Assuming that W=8 inches, Rprint=720 dpi, Nn=180 (nozzles), and Nc=7 (ink colors), the capacity CP[BF14] of the output buffer BF14 is approximately 0.9 Mbytes.

At step S15, after the dot data for the single pass have been prepared, the dot data are transferred to the printer 200. In addition, once the dot data for the single pass have been prepared, the oldest image data for the number of lines corresponding to the sub scanning feed amount F (FIG. 4) among the image data stored in the line selection process buffer BF12 are updated into new image data. In the example of FIG. 4, the feed amount F corresponds to five lines in the printing resolution or 2.5 lines in the image data resolution. Therefore, once the process for the single pass have been completed, the image data for 2 or 3 lines among the image data stored in the line selection process buffer BF12 are updated.

In the embodiment described above, the total capacity of the buffers BF11 through BF14 is approximately 6.0 Mbytes.

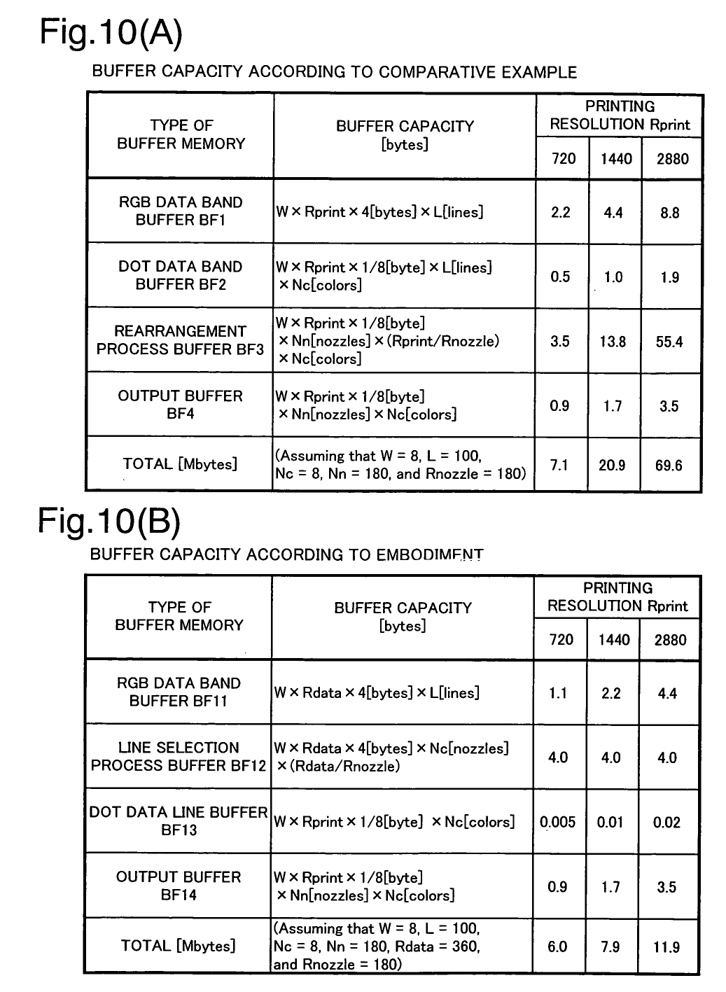

FIGS. 10(A) and 10(B) show a comparison of the buffer memory capacities according to the comparative example and the embodiment described above. When the printing resolution Rprint is equal to 720 dpi, the total capacity of the buffer memory is approximately 7.1 Mbytes in the comparative example while it is approximately 6.0 Mbytes in the embodiment. When the printing resolution Rprint is equal to 1440 dpi, the total capacity of the buffer memory is approximately 20.9 Mbytes in the comparative example while it is approximately 7.9 Mbytes in the embodiment. When the printing resolution Rprint is equal to 2880 dpi, the total capacity of the buffer memory is approximately 69.6 Mbytes in the comparative example while it is approximately 11.9 Mbytes in the embodiment. As can be seen from this explanation, the increased printing resolution Rprint results in the increased capacity of the buffer memory both in the comparative example and in the embodiment, but the increasing rate in the embodiment is significantly lower than that in the comparative example. The reason is that the increased printing resolution Rprint results in the significantly increased capacity of the rearrangement process buffer BF3 in the comparative example. As can be seen from the buffer capacities expressed by the parameters (in the second column of FIGS. 10(A) and 10(B)), the capacity of the rearrangement process buffer BF3 increases in proportion to the printing resolution Rprint squared. On the other hand, the embodiment uses no buffer whose capacity increases in proportion to the printing resolution Rprint squared. On the contrary, the capacity of the line selection process buffer BF12 of the embodiment does not differ even if the printing resolution Rprint has been changed. It can be understood that this difference results in the difference in total capacity.

In this manner, the above-mentioned embodiment creates the dot data by storing the color image data for the area corresponding to the height H2 (FIG. 8) of the print head 210 in the sub scanning direction into the line selection process buffer BF12, selectively reading out the image data of lines subject to printing from the buffer BF12, and then performing the color conversion and dither process on the image data, instead of performing the rearrangement process after the creation of dot data as in the comparative example. This can prevent the excessive increase in the total capacity of the buffer memory even if the printing resolution Rprint has been increased.

D. Modifications:

The several embodiments of the present invention have been described here. The present invention is not restricted to the above embodiments, but there may be many other aspects without departing from the scope or spirit of the present invention. For example, the following modifications are applicable.

D1. Modification 1:

Although all of the processes shown in FIG. 7 are performed by the printer driver 110 in the above-mentioned embodiment, all or part of these processes may be performed by a controller included in the printer 200. In the example of FIG. 7, for example, the printer driver 110 may perform the processes up to step S12 while the controller included in the printer 200 may perform the processes after step S12. In this case, the total capacity of the buffer memory used by the printer driver 110 is approximately 5.5 Mbytes while the total capacity of the buffer memory used by the controller of the printer 200 is approximately 0.9 Mbytes. In this manner, the printer driver 110 and the controller of the printer 200 appropriately share the dot data creation process for creating the dot data for the single main scan pass from the color image data, thereby ensuring the proper allocation of the buffer memory capacity used by the printer driver 110 and the printer controller.

In addition, the printer driver 110 may take advantage of the above characteristics to adaptively determine, according to the environment of the printing system, which of the computer 100 or the printer 200 performs the processes at steps S11 through S15 of FIG. 7. For example, prior to the print data creation process, the printer driver 110 may check a remaining amount of available memory resource in the computer 100 to switch between the computer and the printer 200 for the processes of steps S11 through S15 according to the result of the check. This ensures the proper load distribution according to the environment of the printing system during the printing, thereby enabling the print data to be created faster.

D2. Modification 2:

Although the dither process is used to create the dot data in the above embodiment, other halftone processes (e.g. density pattern method) that compare the color image data with a threshold pattern are applicable instead.

D3. Modification 3:

Although the RGB data are stored into the line selection process buffer BF12 (FIG. 7) in the above embodiment, image data of the L*a*b* color system or ink color data after the conversion into ink colors may be stored instead of the RGB data. Even in the case that the ink color data are stored into the buffer BF12, it is preferable that the ink color data have the same resolution (360 dpi in the embodiment) as the original color image data. Then, the dither process is performed for each print pixel on the ink color data (which are also a type of color image data) read out from the line selection process buffer BF12. However, it is more preferable in terms of buffer capacity that the original color image data such as RGB data are stored into the line selection process buffer BF12 since four or more types of ink colors are typically used.

As can be seen from the above description, it is preferable that at least the halftone process according to the printing resolution is performed on the color image data read out from the line selection process buffer BF12 to create the dot data.

D4. Modification 4:

Among the four buffers BF11 through BF14 shown in FIG. 7, the band buffer BF11 and the dot data line buffer BF13 may be omitted. In this case, the image data after the rasterization at step S11 are directly stored into the line selection process buffer BF12. In addition, when dot data for the single pixel are created at step S13, the horizontal dot position selection process, which determines whether or not the dot data are required, is performed without storing the dot data into the line buffer BF13 to store only the dot data of required pixels (or recording-subject pixels) into the output buffer BF14.

D5. Modification 5:

Although the ink jet printer is used in the above embodiment, the present invention is also applicable to other types of printers.

What is claimed is:

1. A method of creating dot data representing recording states of ink dots in order to perform color printing by ejecting ink from nozzles of a print head during main scanning to thereby record ink dots on a printing medium, the method comprising the steps of:
(a) providing a print head that includes a plurality of nozzle groups for ejecting plural types of inks, respectively, each of the plurality of nozzle groups including a plurality of nozzles whose nozzle pitch in a sub scanning direction is larger than a pitch of print pixels;
(b) storing color image data for an area corresponding to a height of entire nozzles in the sub scanning direction that are used during color printing into a first buffer;
(c) selecting color image data that represent a color image part on a plurality of printing-subject lines subject to recording of ink dots performed by the plurality of nozzle groups during a single main scan from the first buffer;
(d) performing at least a halftone process that uses a threshold pattern having a printing resolution on the selected color image data on the plurality of printing-subject lines to create dot data representing recording states of ink dots in print pixels on the selected printing-subject lines, and storing the dot data into a second buffer; and
(e) outputting the dot data from the second buffer.

2. A method according to claim 1, wherein
the color image data have a lower resolution than the printing resolution.

3. A method according to claim 1, wherein
the color image data stored into the first buffer are expressed in a first color system that uses three color components to express any colors, and
the step (d) includes converting from the first color system to a second color system that uses the plural types of inks to express any colors prior to the halftone process.

4. A method according to claim 1, wherein
when print pixel positions on each printing-subject line subject to recording of ink dots during the single main scan include recording-subject pixel positions that are subject to recording of ink dots and non recording-subject pixel positions that are not subject to recording of ink dots during the single main scan, the step (d) includes replacing values of dot data for the non recording-subject pixel positions among dot data on each printing-subject line with a value representing non-formation of dot.

5. A print control device for creating dot data representing recording states of ink dots in order to perform color printing by ejecting ink from nozzles of a print head during main scanning to thereby record ink dots on a printing medium, the print head having a plurality of nozzle groups for ejecting plural types of inks, respectively, each of the plurality of nozzle groups including a plurality of nozzles whose nozzle pitch in a sub scanning direction is larger than a pitch of print pixels, the print control device comprising:
a first processor for storing color image data for an area corresponding to a height of entire nozzles in the sub scanning direction that are used during color printing into a first buffer;
a second processor for selecting color image data that represent a color image part on a plurality of printing-subject lines subject to recording of ink dots performed by the plurality of nozzle groups during a single main scan from the first buffer;
a third processor for performing at least a halftone process that uses a threshold pattern having a printing resolution on the selected color image data on the plurality of printing-subject lines to create dot data representing recording states of ink dots in print pixels on the selected printing-subject lines, and storing the dot data into a second buffer; and
a fourth processor for outputting the dot data from the second buffer.

6. A print control device according to claim 5, wherein
the color image data have a lower resolution than the printing resolution.

7. A print control device according to claim 5, wherein
the color image data stored into the first buffer are expressed in a first color system that uses three color components to express any colors, and
the third processor performs conversion from the first color system to a second color system that uses the plural types of inks to express any colors prior to the halftone process.

8. A print control device according to claim 5, wherein
when print pixel positions on each printing-subject line subject to recording of ink dots during the single main scan include recording-subject pixel positions that are subject to recording of ink dots and non recording-subject pixel positions that are not subject to recording of ink dots during the single main scan, the third processor performs replacing values of dot data for the non recording-subject pixel positions among dot data on each printing-subject line with a value representing non-formation of dot.

9. A computer program product for creating dot data representing recording states of ink dots in order to perform color printing by ejecting ink from nozzles of a print head during main scanning to thereby record ink dots on a printing medium, the print head having a plurality of nozzle groups for ejecting plural types of inks, respectively, each of the plurality of nozzle groups including a plurality of nozzles whose nozzle pitch in a sub scanning direction is larger than a pitch of print pixels, the computer program product comprising:
a computer readable medium; and
a computer program stored on the computer readable medium, the computer program causing a computer to implement the functions of:
(a) storing color image data for an area corresponding to a height of entire nozzles in the sub scanning direction that are used during color printing into a first buffer;
(b) selecting color image data that represent a color image part on a plurality of printing-subject lines subject to recording of ink dots performed by the plurality of nozzle groups during a single main scan from the first buffer;
(c) performing at least a halftone process that uses a threshold pattern having a printing resolution on the selected color image data on the plurality of printing-subject lines to create dot data representing recording states of ink dots in print pixels on the selected printing-subject lines, and storing the dot data into a second buffer; and
(d) outputting the dot data from the second buffer.

10. A computer program product according to claim 9, wherein
the color image data have a lower resolution than the printing resolution.

11. A computer program product according to claim 9, wherein
the color image data stored into the first buffer are expressed in a first color system that uses three color components to express any colors, and
the function (d) includes converting from the first color system to a second color system that uses the plural types of inks to express any colors prior to the halftone process.

12. A computer program product according to claim 9, wherein
when print pixel positions on each printing-subject line subject to recording of ink dots during the single main scan include recording-subject pixel positions that are subject to recording of ink dots and non recording-subject pixel positions that are not subject to recording of ink dots during the single main scan, the function (d) includes replacing values of dot data for the non recording-subject pixel positions among dot data on each printing-subject line with a value representing non-formation of dot.
